(19) United States
(12) Patent Application Publication
(10) Pub. No.: US 2026/0197638 A1
(43) Pub. Date: Jul. 9, 2026

(54) Communications Systems with Secure Access Point Discovery

(71) Applicant: Apple Inc., Cupertino, CA (US)

(72) Inventors: Jarkko L Kneckt, Los Gatos, CA (US); Sidharth R Thakur, Los Altos, CA (US); Yong Liu, Campbell, CA (US); Yanjun Sun, San Diego, CA (US); Andrew T Kezys, San Francisco, CA (US); Pooya Monajemi, Sunnyvale, CA (US)

(21) Appl. No.: 19/427,792

(22) Filed: Dec. 19, 2025

Related U.S. Application Data
(60) Provisional application No. 63/743,540, filed on Jan. 9, 2025.

(51) Int. Cl. H04W 12/037; H04W 12/02

(52) U.S. Cl. CPC H04W 12/037; H04W 12/02

(57) ABSTRACT

A communication system is provided in which a Basic Service Set (BSS) privacy enhancement (BPE) access point (AP) communicates with a BPE station (STA). Prior to association, the STA may generate a STA-ID by inputting current addresses of the AP and STA with an AP identity key to a hash algorithm. The STA may use a Pre-Association Security Negotiation (PASN) procedure to discover the AP. The STA may transmit PASN MSG1 including the STA-ID to the AP. The AP may verify that the STA is authorized to receive AP security parameters using the STA-ID. Responsive to successful verification, the AP may transmit PASN MSG2 to the STA. The STA and AP may derive a transient key (TK) using information from the PASN messages and may convey management frames encrypted using the TK. The management frames may be used to associate the STA with the AP.

This application claims the benefit of provisional patent application No. 63/743,540, filed January 9, 2025, which is hereby incorporated by reference herein in its entirety.

### FIELD

This disclosure relates generally to wireless communications, including wireless communications by electronic devices.

### BACKGROUND

Communications systems and methods are used to convey wireless data between nodes of a communications network. The nodes can include user equipment devices, wireless access points, wireless base stations, or other electronic devices.

It can be challenging to ensure that communications systems exhibit sufficient levels of performance. If care is not taken, communication between nodes of a communications network can exhibit excessive latency, can consume excessive resources, or can exhibit insufficient levels of data security.

### SUMMARY

A communication system is provided in which access points (APs) communicate with stations (STAs) (e.g., under an 802.11 protocol). An AP may be a Basic Service Set (BSS) privacy enhancement (BPE) AP. The STA may be a BPE STA. The AP may transmit privacy beacons to the STA. The AP may encrypt the privacy beacons using an AP identity key. The privacy beacons may identify a current address of the AP. Prior to associating with the AP, the STA may generate a STA identifier (STA-ID) by inputting at least the current address of the AP, a current address of the STA, and the AP identity key to a cryptographic function.

The STA may perform a scan procedure to discover and associate with the AP. The scan procedure may be a Pre-Association Security Negotiation (PASN) procedure. The STA may transmit a first PASN message (PASN MSG1) to the AP that includes the STA-ID. The AP may verify that the STA is authorized to receive a set of AP security parameters using the STA-ID from PASN MSG1. In response to verifying that the STA is authorized, the AP may transmit a second PASN message (PASN MSG2) to the STA. The STA and the AP may derive the same transient key (TK) using information from the PASN messages. The STA may convey management frames with the AP that are encrypted using the TK. The STA may use the management frames to associate with the AP.

If desired, the PASN MSG1 transmitted by the STA may include an AP security parameter request field indicative of the STA needing the AP security parameters from the AP. The AP may transmit the AP security parameters to the STA encrypted by the TK. If desired, the AP may transmit the AP security parameters to the STA after a transient key adoption delay period. If desired, the delay period may be selected based on a transient key adoption delay of the STA included in the PASN MSG1 and/or a transient key adoption delay of the AP included in the PASN MSG2.

### BRIEF DESCRIPTION OF THE DRAWINGS

FIG. 1 is a diagram of an illustrative wireless communications system in with some embodiments.

FIG. 2 is a schematic diagram of an illustrative wireless station (STA) in accordance with some embodiments.

FIG. 3 is a schematic diagram of an illustrative wireless access point (AP) in accordance with some embodiments.

FIG. 4 is a flow chart of illustrative operations involved in performing wireless communications between an AP and a STA in accordance with some embodiments.

FIG. 5 is a timing diagram of an illustrative pre-association scan between a STA and an AP in accordance with some embodiments.

FIG. 6 is a diagram showing how an illustrative STA may generate a STA identifier for use in a pre-association scan in accordance with some embodiments.

FIG. 7 is a timing diagram of an illustrative pre-association security parameter query between a STA and an AP in accordance with some embodiments.

FIG. 8 is a diagram showing two examples of illustrative payloads of Pre-association Security Negotiation messages that may be conveyed between a STA and an AP during pre-association communications in accordance with some embodiments.

FIG. 9 is a timing diagram of another illustrative pre-association security parameter query between a STA and an AP in accordance with some embodiments.

### DETAILED DESCRIPTION

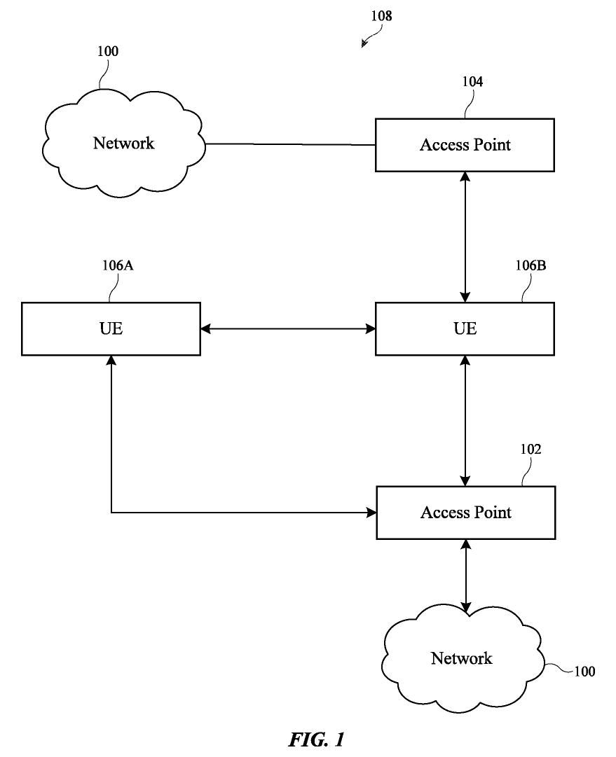

FIG. 1 illustrates an example of a wireless communication system 108 (sometimes also referred to herein as wireless communications network 108, communications network 108, network 108, or system 108). It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown in FIG. 1, the exemplary wireless communication system 108 includes an access point (AP) 104, which communicates over a transmission medium with one or more wireless devices 106 (e.g., a first wireless device 106A, a second wireless device 106B, etc.). Wireless devices 106A and 106B may be user devices (e.g., user equipment (UE) devices), such as stations (STAs), non-AP STAs, or wireless local area network (WLAN) devices. Wireless devices 106 are sometimes referred to herein as STAs 106 or clients 106.

STA 106 may be a device with wireless network connectivity such as a mobile (e.g., cellular) telephone, a hand-held device, a wearable device (e.g., a wristwatch device, pendant device, ring device, head-mounted device such as a virtual, mixed, and/or augmented reality headset, goggles, helmet, or glasses, etc.), a computer (e.g., a desktop computer, laptop computer, a computer monitor containing an embedded computer, etc.), a tablet computer, a media player, headphones, one or two wireless earbuds, a television, a gaming device or console, a navigation device, an embedded system such as a system in which electronic equipment with a display is mounted in a kiosk or automobile, a wireless internet-connected voice-controlled speaker, a home entertainment device, a remote control device, a gaming controller, a user input device, peripheral, or accessory, an electronic stylus or pen, an unmanned aerial vehicle (UAV), an unmanned aerial controller (UAC), an automobile, computing equipment integrated into a vehicle or kiosk, equipment that implements the functionality of two or more of these devices, or virtually any type of wireless device.

STA 106 may include a processor (processing element) that is configured to execute program instructions stored in memory. STA 106 may perform any of the method embodiments described herein by executing such stored instructions. Alternatively, or in addition, STA 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

Wireless communications system 108 may include one or more wireless access points (APs) such as AP 102. AP 102 may be a stand-alone AP or an enterprise AP and may include hardware that enables wireless communication with STAs 106 such as STA 106A and STA 106B. AP 102 may also be equipped to communicate with a network 100 (e.g., a WLAN, an enterprise network, and/or another communication network connected to the Internet, among various possibilities). Thus, AP 102 may facilitate communication among STAs 106 and/or between STAs 106 and network 100. AP 102 can be configured to provide communications over one or more wireless technologies, such as any of IEEE 802.11 a, b, g, n, ac, ad, ax, ay, be, bn, and/or other 802.11 versions, or a cellular protocol, such as 5G or LTE, including in an unlicensed band (LAA).

Network 100 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of network 100 may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of network 100 may include network switches, network routers, optical add-drop multiplexers, other multiplexers, repeaters, modems, portals, gateways, servers, network cards (line cards), wireless access points, wireless base stations, and/or any other desired network components. The network nodes in network 100 may include physical components such as electronic devices, servers, computers, network racks, line cards, user equipment, etc., and/or may include virtual components that are logically defined in software and that are distributed across (over) two or more underlying physical devices (e.g., in a cloud network configuration).

The communication area (or coverage area) of AP 102 (or AP 104) may be referred to as a basic service area (BSA) or cell. AP 102 (or AP 104) and STAs 106 may be configured to communicate over the transmission medium using any of various radio access technologies (RATs) or wireless communication technologies, such as Wi-Fi, LTE, LTE-Advanced (LTE-A), 5G NR, ultra-wideband (UWB), etc. A given RAT may, for example, specify the physical methodology used in implementing a corresponding communications protocol (e.g., a WLAN protocol, a wireless personal area network (WPAN) protocol, a cellular telephone protocol such as a 3G protocol, a 4G (LTE) protocol, a 5G (NR) protocol, etc., a UWB protocol, a satellite communications protocol, a satellite navigation protocol, a device-to-device (D2D) protocol, etc.).

AP 102, AP 104, and other similar access points (not shown) operating according to one or more wireless communication technologies may thus be provided as a network, which may provide continuous or nearly continuous overlapping service to STAs 106A and 106B and similar devices over a geographic area (e.g., via one or more communication technologies). A STA may roam from one AP to another AP directly or may transition between APs and cellular network cells, for example.

Note that at least in some instances STA 106 may be capable of communicating using any of multiple wireless communication technologies. For example, STA 106 might be configured to communicate using one or more of Wi-Fi, LTE, LTE-A, 5G NR, Bluetooth, UWB, one or more satellite systems, etc. Other combinations of wireless communication technologies (including more than two wireless communication technologies) are also possible. Likewise, in some instances STA 106 can be configured to communicate using only a single wireless communication technology.

As shown in FIG. 1, the exemplary wireless communication system 108 can also include an AP 104, which communicates over a transmission medium with the wireless device 106B. AP 104 also provides communicative connectivity to network 100. Thus, according to some embodiments, wireless devices may be able to connect to either or both of AP 102 (or a cellular base station (BS)) and AP 104 (or another access point) to access the network 100. For example, a STA may roam from AP 102 to AP 104 based on one or more factors, such as coverage, interference, and capabilities. Note that it may also be possible for AP 104 to provide access to a different network (e.g., an enterprise Wi-Fi network, a home Wi-Fi network, etc.) than the network to which the AP 102 provides access.

In some implementations, STAs 106 (e.g., STAs 106A and 106B) may include handheld devices such as smart phones or tablets, wearable devices such as smart watches or smart glasses, and/or may include any of various types of devices with wireless communication capability. For example, one or more of the STAs 106A and/or 106B may be a wireless device intended for stationary or nomadic deployment such as an appliance, measurement device, control device, etc.

STA 106B may also be configured to communicate with STA 106A. For example, STA 106A and STA 106B may be capable of performing direct device-to-device (D2D) communication. In some embodiments, such direct communication between STAs may also or alternatively be referred to as peer-to-peer (P2P) communication. The direct communication may be supported by AP 102 (e.g., AP 102 may facilitate discovery, among various possible forms of assistance), or may be performed in a manner unsupported by the AP 102. Such P2P communication may be performed using 3GPP-based D2D communication techniques, Wi-Fi-based P2P communication techniques, UWB, Bluetooth (BT), and/or any of various other direct communication techniques, according to various embodiments.

STA 106 may include one or more devices or integrated circuits for facilitating wireless communication, potentially including a WLAN (e.g., Wi-Fi) modem, a cellular modem, and/or one or more other wireless modems. The wireless modem(s) may include one or more processors (processor elements) and various hardware components as described herein. STA 106 may perform any of (or any portion of) the method embodiments described herein by executing instructions on one or more programmable processors. Alternatively, or in addition, the one or more processors may be one or more programmable hardware elements such as an FPGA (field-programmable gate array), or other circuitry, that is configured to perform any of the method embodiments described herein, or any portion of any of the method embodiments described herein. The wireless modem(s) described herein may be used in a STA as defined herein, a wireless device as defined herein, or a communication device as defined herein. The wireless modem described herein may also be used in an AP, a base station, a pico cell, a femto cell, or other similar network side device.

STA 106 may include one or more antennas for communicating using one or more wireless communication protocols or radio access technologies. In some embodiments, STA 106 can be configured to communicate using a single shared radio. The shared radio may couple to a single antenna, or may couple to multiple antennas (e.g., for multiple-input-and-multiple-output (MIMO)) for performing wireless communications. Alternatively, STA 106 may include two or more radios, each of which may be configured to communicate via a respective wireless link. Other configurations are also possible.

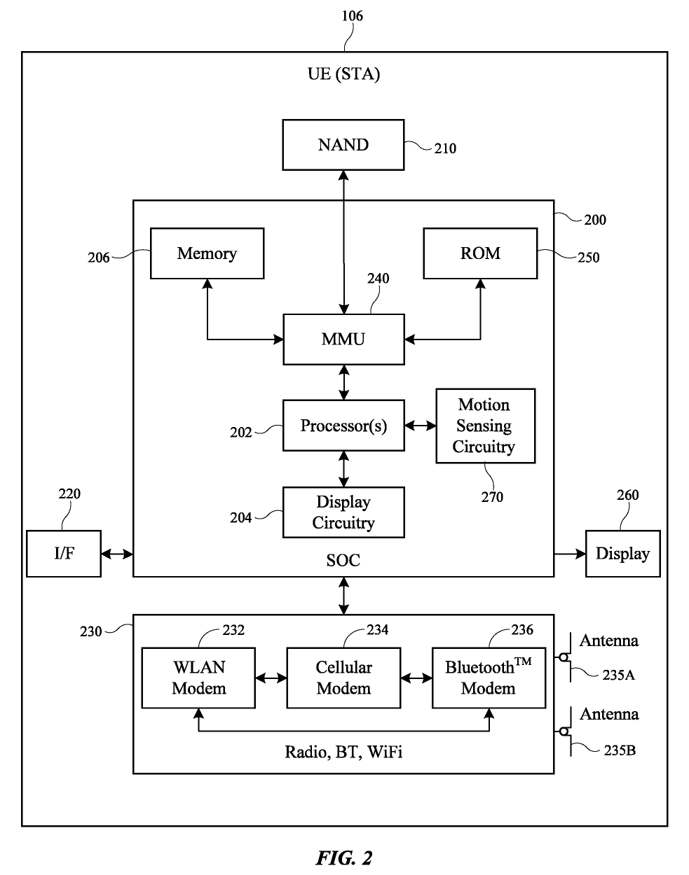

FIG. 2 is one possible block diagram of a STA device such as STA 106. STA 106 is sometimes also referred to herein as UE 106, UE device 106, device 106, electronic device 106, or client 106. STA 106 also may be referred to herein as non-AP STA 106, non-AP device 106, or non-AP client 106. As shown in FIG. 2, STA 106 may include wireless circuitry such as wireless communication circuitry 230, a subsystem such as system on chip (SOC) 200, a display such as display 260, and one or more interfaces such as connector interface (I/F) 220.

SOC 200 may include one or more portions configured for various purposes. For example, as shown in FIG. 2, SOC 200 may include one or more processors 202 and display circuitry 204. Processor(s) 202 may execute program instructions for STA 106. Display circuitry 204 may perform graphics processing and may provide display signals to display 260. Display 260 may be a touch-sensitive display, a force sensitive display, or a display without touch or force sensitivity. Display 260 may include one or more arrays of display pixels that emit light containing images, for example.

SOC 200 may also include sensor circuitry such as motion sensing circuitry 270. Motion sensing circuitry 270 may detect motion of the STA 106 using, for example, a gyroscope, accelerometer, inertial measurement unit (IMU), compass, and/or any of various other motion sensing components. Processor(s) 202 may also be coupled to memory management unit (MMU) 240, which may be configured to receive addresses from processor(s) 202 and may translate those addresses to locations in memory or other storage circuitry (e.g., memory 206, read only memory (ROM) 250, flash (NAND) memory 210, etc.). MMU 240 may be configured to perform memory protection and page table translation or set up. In some embodiments, MMU 240 may be included as a portion of processor(s) 202.

SOC 200 may be coupled to various other circuits in STA 106. For example, SOC 200 may be coupled to various types of memory (e.g., flash memory 210), connector interface 220 (e.g., for coupling to a computer system, dock, charging station, etc.), display 260, and wireless communication circuitry 230 (e.g., for performing wireless communications under LTE, LTE-A, 5G NR, Bluetooth, Wi-Fi, NFC, GPS, UWB, etc.).

STA 106 may include at least one antenna 235. If desired, STA 106 may include multiple antennas 235 such as at least a first antenna 235A and a second antenna 235B. STA 106 may use antennas 235 to perform wireless communication with access points, base stations, and/or other devices. For example, STA 106 may use antennas 235A and 235B to perform the wireless communication with APs 102 and/or 104 of FIG. 1. As noted above, STA 106 may, in some embodiments, be configured to communicate wirelessly using multiple wireless communication standards or radio access technologies (RATs).

Wireless communication circuitry 230 may include one or more modems such as WLAN (e.g., Wi-Fi) modem 232, cellular modem 234, and Bluetooth modem 236. If desired, wireless communication circuitry 230 may include additional modems for handling other RATs or wireless communications technologies. STA 106 may use WLAN modem 232 (sometimes also referred to herein as Wi-Fi modem 232) to perform Wi-Fi or other WLAN communications (e.g., on an 802.11 network) with one or more external devices (e.g., AP 104 and/or 102 of FIG. 1). STA 106 may use Bluetooth modem 236 to perform Bluetooth communications or other WPAN communications with one or more external devices (e.g., another STA 106). STA 106 may use cellular modem 234 to perform cellular communications with one or more wireless base stations according to one or more cellular communication technologies (e.g., in accordance with one or more 3GPP specifications).

As described herein, STA 106 may include hardware and software components for implementing embodiments of this disclosure. For example, one or more components of the wireless communication circuitry 230 (e.g., Wi-Fi modem 232, cellular modem 234, BT modem 236) of the STA 106 may be configured to implement part or all of the methods described herein, e.g., by one or more processors executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit). STA 106 may include support structures such as a housing. The housing may include conductive and/or dielectric housing walls, layers, and/or other structures.

If desired, STA 106 may include additional include input-output devices (not shown for the sake of clarity). The input-output devices may be used to allow data to be supplied to STA 106 and to allow data to be provided from STA 106 to external devices. The input-output devices may include user interface devices, data port devices (e.g., interface 220), touch sensors, displays (e.g., display 260), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to STA 106 using wired or wireless connections (e.g., some of the input-output devices may be peripherals that are coupled to a main processing unit or other portion of STA 106 via a wired or wireless link).

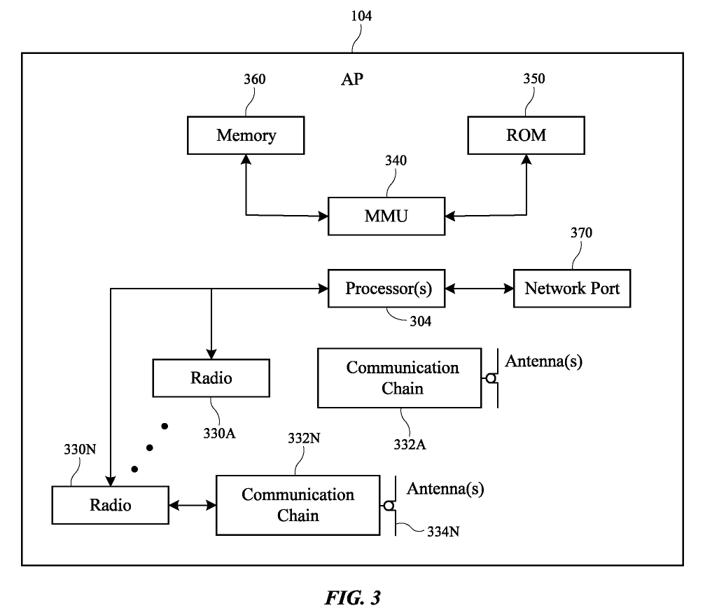

FIG. 3 is an example block diagram of an electronic device such as AP 104 (or equivalently AP 102 of FIG. 1). In some instances (e.g., in an 802.11 communication context), AP 104 may also be referred to as an AP STA. It is noted that the AP of FIG. 3 is merely one example of a possible access point. As shown, AP 104 may include one or more processors 304, which may execute program instructions for AP 104. Processor(s) 304 may also be coupled to MMU 340, which may be configured to receive addresses from processor(s) 304 and to translate those addresses to locations in memory (e.g., memory 360 and ROM 350) or to other storage circuitry, circuits, or devices.

AP 104 may include at least one network port 370. Network port 370 may be configured to couple to a network and to provide multiple devices, such as STAs 106, with access to the network (e.g., network 100 of FIG. 1). Network port 370 (or an additional network port) may also or alternatively be configured to couple to a cellular network (e.g., a core network (CN) of a cellular service provider). The core network may provide mobility related services and/or other services to a plurality of UE devices (e.g., STAs 106). In some cases, network port 370 may couple to a telephone network via the core network, and/or the core network may provide a telephone network (e.g., among other UE devices serviced by the cellular service provider).

AP 104 may include one or more radios 330A-330N, each of which may be coupled to a respective communication chain 332 and at least one antenna 334, and possibly multiple antennas (e.g., a first radio 330A coupled to antenna 334A via communication chain 332A, an Nth radio 330N coupled to antenna 334N via communication chain 332N, etc.). Radios 330 may be configured to operate as wireless transceivers that communicate with STAs 106 via communication chains 332 and antennas 334. Antenna(s) 334A-N communicate with their respective radios 330A-N via communication chains 332A-N. Communication chains 332 may be receive chains, may be transmit chains, or may include both transmit and receive chains. Radios 330A-N may be configured to communicate in accordance with various wireless communication standards including, but not limited to, LTE, LTE-A, 5G NR, 6G, UWB, WLAN (Wi-Fi), WPAN (BT), etc. If desired, AP 104 may be configured to operate on multiple wireless links using the one or more radios 330A-N, where each radio is used to operate on a respective wireless link.

AP 104 may be configured to communicate wirelessly using one or multiple wireless communication standards. In some instances, AP 104 may include multiple radios, which may enable the network entity to communicate according to multiple wireless communication technologies. For example, as one possibility, AP 104 may include an LTE or 5G NR radio for performing communication according to LTE or 5G as well as a Wi-Fi radio for performing communication according to Wi-Fi. In such a case, AP 104 may be capable of operating as both a cellular base station and a Wi-Fi access point. As another possibility, AP 104 may include a multi-mode radio, which is capable of performing communications according to any of multiple wireless communication technologies (e.g., NR and Wi-Fi, NR and LTE, etc.). As still another possibility, AP 104 may be configured to act exclusively as a Wi-Fi access point, e.g., without cellular communication capability.

As described further herein, AP 104 may include hardware and software components for implementing or supporting implementation of features described herein. Processor(s) 304 of AP 104 may be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, processor(s) 304 may be configured as a programmable hardware element, such as an FPGA (Field Programmable Gate Array) or ASIC (Application Specific Integrated Circuit), or a combination thereof. Alternatively (or in addition) the processor(s) 304 of AP 104, in conjunction with one or more of the other components 330, 332, 334, 340, 350, 360, 370 may be configured to implement, or support implementation of, part or all of the features described herein.

Radio(s) 330 on AP 104 may use antenna(s) 334 (FIG. 3) and wireless communication circuitry 230 on STA 106 may use antenna(s) 235 (FIG. 2) to transmit and/or receive radio-frequency signals within different frequency bands at radio frequencies (sometimes referred to herein as communications bands or simply as a “bands”). The frequency bands handled by AP 104 and STA 106 may include satellite communications bands (e.g., the C band, S band, L band, X band, W band, V band, K band, Kₐ band, K ᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz,6G bands, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Antenna(s) 334 (FIG. 3) and antenna(s) 235 (FIG. 2) may be formed using any desired antenna structures. For example, the antennas may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas may include antenna resonating elements formed from conductive portions of a device housing (e.g., peripheral conductive housing structures extending around a periphery of a display on STA 106). Filter circuitry, switching circuitry, impedance matching circuitry, and/or other antenna tuning components may be adjusted to adjust the frequency response and wireless performance of the antennas over time. If desired, multiple antennas may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Wireless communication circuitry 230 may convey radio-frequency signals using antenna(s) 235 (FIG. 2). Radio(s) 330 may convey radio-frequency signals using antenna(s) 334 (FIG. 3). The term “convey radio-frequency signals” as used herein means the transmission and/or reception of the radio-frequency signals (e.g., for performing unidirectional and/or bidirectional wireless communications with external wireless communications equipment). The term “convey wireless data” as used herein means the transmission and/or reception of the wireless data (e.g., as carried by corresponding radio-frequency signals). Antennas may transmit radio-frequency signals by radiating the radio-frequency signals into free space (or to free space through intervening device structures such as a dielectric cover layer). Antennas may additionally, or alternatively, receive radio-frequency signals from free space (or through intervening devices structures such as a dielectric cover layer). The transmission and reception of radio-frequency signals by antennas each involve the excitation or resonance of antenna currents on an antenna resonating element in the antenna by the radio-frequency signals within the frequency band(s) of operation of the antenna.

Wireless communication circuitry 230 may be coupled to antenna(s) 235 (FIG. 2) over one or more radio-frequency transmission lines. Radio(s) 330 may be coupled to antenna(s) 334 (FIG. 3) over one or more radio-frequency transmission lines. Communication chain(s) 332 (FIG. 3) may be disposed on the radio-frequency transmission lines between antenna(s) 334 and radio(s) 330. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios or modems if desired. Radio-frequency front end (RFFE) modules may be interposed on one or more of the radio-frequency transmission lines if desired (e.g., within communication chain(s) 332 of FIG. 3 or within wireless communication circuitry 230 of FIG. 2). The radio-frequency front end modules may include substrates, integrated circuits, chips, or packages that are separate from the radios or modems and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Processor(s) 202 (FIG. 2) and processor(s) 304 (FIG. 3) may each include one or more processors such as microprocessors, microcontrollers, digital signal processors, host processors, baseband processing circuitry (e.g., one or more baseband processors or baseband processor integrated circuits), application specific integrated circuits (ASICs), FPGAs, central processing units (CPUs), graphics processing units (GPUs), etc. If desired, radio(s) 330 (FIG. 3) and/or wireless communication circuitry 230 may also include one or more processors. Baseband circuitry in STA 106 and/or AP 104 may, for example, access a communication protocol stack on corresponding storage circuitry (e.g., memory 206 of FIG. 2 or memory 360 of FIG. 3) to: perform user plane functions at a physical (PHY) layer, data link or media access control (MAC) layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

AP 104 (or AP 102 of FIG. 1) may communicate with a STA 106 over a corresponding wireless communication link. Radio-frequency signals may be wirelessly conveyed between the radios and antennas on AP 104 and STA 106 to support the wireless communication link. The radio-frequency signals may include wireless data modulated onto one or more carriers of the radio-frequency signal (e.g., by a transmitter in radio 330 of AP 104 or a transmitter in a modem on wireless communication circuitry 230 of STA 106). The wireless data may be organized, modulated onto the radio-frequency signals, and demodulated from the radio-frequency signals (e.g., by a receiver in radio 330 of AP 104 or a receiver in a modem on wireless communication circuitry 230 of STA 106) according to a corresponding communications protocol or standard (e.g., an IEEE 802.11 protocol or standard). The radio-frequency signals may be conveyed in one or more frequency bands associated with the communications protocol.

Implementations in which AP 104 and STA 106 communicate according to an IEEE 802.11 protocol or standard are described herein as an example. Under an 802.11 protocol, the wireless data is organized into a series or flow of frames (e.g., media access control (MAC) frames) carried by the radio-frequency signals. The frames, which are sometimes also referred to as packets, may include management frames, control frames, data frames, beacon frames, association frames, authentication frames, acknowledgement (ACK) frames, block ACK frames, trigger frames, trigger response frames, and/or other types of frames. Each frame may include a frame header, body (e.g., after the header), and trailer (e.g., after the body). The header may include, for example, source address (SA) information identifying the transmitter of the frame (sometimes also referred to herein as transmitter address (TA) information that identifies a corresponding TA), destination address information identifying the intended recipient of some or all of the frame (sometimes also referred to herein as recipient address (RA) information that identifies a corresponding RA), routing information, identifier information identifying one or more aspects of some or all of the frame (e.g., information identifying the type of frame), Association Identifier (AID) fields, control information, etc. The body may include, for example, a data payload (e.g., a payload of voice data, video data, web browsing data, application data, etc.). The trailer may include checking information that helps to verify the frame to the recipient. The checking information may include a frame check sequence (FCS) or cyclic redundancy check (CRC) field, as examples. If desired, the header, body, and/or trailer may include one or more message integrity check (MIC) fields (e.g., hash values or the output of other cryptographic functions that take as an input different portions of the frame and that are used to verify the integrity of the frame when received by a recipient). Fields of a frame or message are sometimes also referred to herein as elements.

Under a bidirectional communications link between AP 104 and STA 106, frames are conveyed both from AP 104 to STA 106 and from STA 106 to AP 104. STA 106 may transmit one or more ACK frames or block ACK frames to AP 104 to acknowledge the successful receipt of one or more frames transmitted by AP 104. AP 104 may transmit one or more ACK frames or block ACK frames to STA 106 to acknowledge the successful receipt of one or more frames transmitted by AP STA 106.

Radio-frequency signals are transmitted in a downlink (DL) direction from AP 104 to STA 106. Radio-frequency signals transmitted in the DL direction are sometimes also referred to herein as DL signals. The DL signals may carry DL data (e.g., DL frames transmitted by AP 104 to STA 106). Radio-frequency signals are transmitted in an uplink (UL) direction from STA 106 to AP 104. Radio-frequency signals transmitted in the UL direction are sometimes also referred to herein as UL signals. The UL signals may carry UL data (e.g., UL frames transmitted by STA 106 to AP 104).

A given AP 104 may support, maintain, and/or implement a Basic Service Sets (BSS) used in communicating with at least one STA 106 (e.g., according to the corresponding 802.11 protocol). If desired, a single physical AP 104 may concurrently support, maintain, and/or implement multiple BSS’s (e.g., may support wireless communications with different STAs associated with multiple BSS’s). The AP may, for example, utilize a first BSS to communicate with a first set of one or more STAs 106, a second BSS to communicate with a second set of one or more STAs 106, etc. When communications between AP 104 and a given STA 106 are initiated, the STA associates (registers) with AP 104 and is thereafter associated with a corresponding BSS of the AP (a procedure referred to as Association). A BSS may include and/or identify corresponding communications/operating parameters, device capabilities, security level information, and/or other information associated with the communications services provided by AP 104 to one or more STAs under that BSS.

Each BSS may be identified by a corresponding BSS identifier (BSSID). The BSSID may, for example, represent or correspond to a particular network address (e.g., MAC address) and/or wireless network name that is established, possessed, and/or maintained by the AP for wirelessly communicating using the corresponding BSS. If desired, a given AP 104 may concurrently or simultaneously support, implement and/or maintain multiple BSSIDs, in a communications scheme sometimes referred to herein as performing multiple BSSID (M-BSSID) operations or M-BSSID communications. When configured to perform M-BSSID communications, each BSSID maintained by AP 104 corresponds to a different network address (e.g., MAC address) and wireless network name maintained and operated by the AP.

Consider one example in which AP 104 is a Wi-Fi router or hot spot on a college campus and that is configured to perform M-BSSID communications. In this example, AP 104 may concurrently maintain a first BSSID named “STUDENT” for STAs 106 operated by students of the college campus and corresponding to a first MAC address of AP 104, a second BSSID named “STAFF” for STAs 106 operated by staff of the college campus and corresponding to a second MAC address of AP 104, a third BSSID named “GUEST” for STAs 106 operated by guests of the college campus, etc. Each BSSID may have different respective operating characteristics, security configurations, and/or settings. When a STA 106 enters the wireless coverage area of the AP, the user of the STA may interact with a user interface of the STA to select one of the BSSIDs of the AP to connect to. The AP may then associate the STA with or to that BSSID (e.g., if the STA meets one or more security conditions related to the BSSID such as being registered to a user who is granted access to that BSSID, providing a correct password to access that BSSID, etc.). Once associated with a given BSSID, the STA and the AP use that BSSID (e.g., the BSS identified by the BSSID) to convey wireless data. This example is illustrative and non-limiting.

In implementations that are described herein as an example, an AP 104 and a STA 106 support and communicate under a BSS Privacy Enhancement (BPE) scheme (e.g., as defined by a 802.11 communications protocol governing communications between AP 104 and STA 106). APs 104 that support BPE communications are sometimes also referred to as BPE APs but are referred to herein simply as APs 104 for the sake of simplicity. STAs 106 that support BPE communications are sometimes also referred to as BPE STAs or BPE non-AP STAs but are referred to herein simply as STAs 106 for the sake of simplicity. The BPE scheme may help to protect privacy for the AP and the STA. STAs that do not support BPE communications may be unable to associate with a BPE AP.

Under the BPE scheme, both the AP and the STA may periodically update and anonymize their corresponding link-specific network addresses (e.g., MAC addresses) to help to increase privacy and security. For example, the AP may update its network (e.g., MAC) address to a different respective anonymized or randomized address during different time periods (sometimes also referred to as epochs). Similarly, the STA may update its network (e.g., MAC) address to a different respective anonymized or randomized address during each of the different time periods. In addition, under BPE, all management frames transmitted by the AP and the STA may be encrypted prior to transmission.

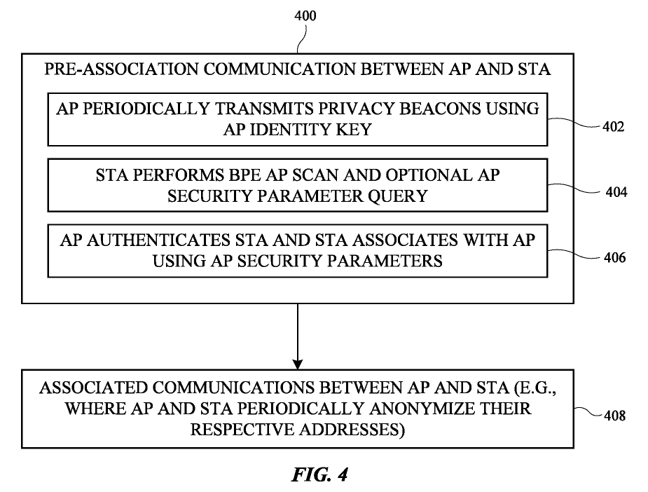

FIG. 4 is a flow chart of illustrative operations involved in performing wireless communications between a given STA 106 and a corresponding AP 104 in communications system 108 (FIG. 1) (e.g., under a BPE scheme). At operation 400 of FIG. 4, STA 106 and AP 104 may perform pre-association communications (e.g., prior to AP 104 associating with, registering with, or connecting to AP 104). AP 104 may use the pre-association communications to authenticate STA 106. STA 106 may use the pre-association communications to associate with AP 104. AP 104 and/or STA 106 may transmit one or more management frames (“MGMT”) during pre-association communications. The management frames may carry information used by AP 104 to authenticate STA 106 and/or may carry information used by STA 106 to associate with AP 104. Once AP 104 has successfully authenticated STA 106 and STA 106 has associated with AP 104, processing may proceed to operation 408.

At operation 408, STA 106 and AP 104 may perform associated communications (e.g., while STA 106 is associated with, registered with, and connected to AP 104). This may involve the transmission of UL data from STA 106 to AP 104 and/or the transmission of DL data from AP 104 to STA 106 (e.g., in physical protocol data unit (PPDU) frames or other types of data or non-management frames). Under the BPE scheme, AP 104 and STA 106 may periodically change/anonymize their respective network addresses (e.g., MAC addresses) during different epochs to help enhance privacy. If desired, AP 104 and STA 106 may also randomly change the packet number (PN) and/or sequence number (SN) of transmitted frames between epochs. Processing may loop back to operation 400 if/when STA 106 disconnects or disassociates from AP 104.

For STA 106 to successfully associate with AP 104, AP 104 may first need to successfully authenticate STA 106 (e.g., to ensure that STA 106 is authorized to access the network via AP 104). For AP 104 to successfully authenticate STA 106, STA 106 may need to have knowledge of a minimum set of AP security parameters of AP 104 (sometimes also referred to herein as AP configuration parameters or simply as AP parameters). STA 106 may use the AP security parameters to associate with AP 104. The AP security parameters may include, for example, at least a Robust Security Network Element (RSNE) and a Robust Security Network Extension Element (RSNXE) of AP 104. As an example, the STA may need to correctly set RSNE and RSNXE parameters to successfully associate with the AP (e.g., an individual cipher and Authentication Key Management (AKM) Protocol utilized by the STA needs to be supported by the AP, the STA needs to use the correct group cipher (GTK) and group integrity check cipher (IGTK) of the AP, the STA needs to support the same RSNXE settings as the AP, etc.). If the RSNE and the RSNXE parameters are misconfigured by the STA, the STA can fail to associate with the AP.

Under the BPE scheme, pre-association communications between AP 104 and STA 106 (operation 400) may include the transmission of privacy beacons by AP 104 (at operation 402). AP 104 may, for example, periodically transmit privacy beacons (sometimes also referred to as privacy beacon frames, privacy beacon signals, or privacy beacon messages) that include information used by STA 106 to identify or determine whether the transmitting AP is already known to STA 106. Alternatively, AP 104 may transmit a privacy beacon in response to a privacy beacon solicit request frame transmitted by STA 106. AP 104 may encrypt payloads of the privacy beacons using a corresponding AP identity key associated with that particular AP 104. The AP identity key may be known to the STA and the STA may use the AP identity key to decrypt privacy beacons received from the AP. However, prior to association, the STA may not have knowledge of the BSSID of AP 104 and does not obtain any AP security parameters from the transmitted privacy beacons.

At operation 404, STA 106 may perform a BPE AP scan for AP 104. If desired, this may also include an optional AP security parameter query in which AP 104 transmits its AP security parameters to STA 106 in a secure manner. After STA 106 has successfully scanned for AP 104 and after STA 106 has knowledge of the AP security parameters of AP 104, AP 104 may authenticate STA 106 and STA 106 may associate with AP 104 using (based on) the AP security parameters. In some implementations, authentication of STA 106 by AP 104 may involve the transmission of an authentication request by STA 106 (e.g., including or identifying some or all of the AP security parameters as known to STA 106), authentication of the authentication request by AP 104, and the transmission of an authentication response by AP 104 responsive to successful authentication of the authentication request. In some implementations, association with AP 104 by STA 106 may involve the transmission of an association request by STA 106 after or responsive to receipt of the authentication response (e.g., including or identifying some or all of the AP security parameters as known to STA 106 and/or STA link parameters) and transmission of an association response by AP 104 responsive to receipt of the association request (e.g., including or identifying some or all of the AP security parameters and/or other AP link parameters). After receipt of the association response, STA 106 becomes associated with AP 104 and associated communications may be performed. The association request and the association response may be encrypted using a transient key that is shared between or known to both AP 104 and STA 106.

Operations 404 and 406 are sometimes also collectively referred to as a BPE AP discovery procedure or a protected AP discovery procedure. The protected AP discovery procedure may, for example, be a Pre-Association Security Negotiation (PASN) procedure involving the transmission of a series of PASN messages between AP 104 and STA 106. In some implementations, BPE STAs are preconfigured with AP security parameters (e.g., a pre-shared RSNE and RSNXE) for a corresponding AP prior to operation 400. However, preconfiguring the STAs with the AP security parameters may allow only preconfigured STAs to detect a BPE AP from its transmitted privacy beacons. In addition, pre-shared AP security parameters only work if all APs support the same pre-shared AP security parameter values, which may not be the case depending on the deployment of APs in communications system 108. As another option, the STA may attempt to associate with the AP by testing different RSNE and RSNXE settings one-by-one (e.g., using brute force). However, this causes the STA to exhibit excessive communications overhead, complexity, and power consumption, and can cause the AP to consider the STA’s repeated association attempts as a security attack, triggering the AP to stop responding to the STA’s attempts.

In general, knowledge of AP security parameters for a BPE AP is important for the STA. Although parameter mismatch may not reject authentication or association on its own, the STA can use the parameters to optimize association (e.g., if the STA has knowledge of available links and their parameters). It may also be important for the AP security parameters to be encrypted to protect AP and STA privacy. Integrity protection schemes may, for example, help to ensure correctness of shared parameters. A BPE AP may verify that a scanning STA is authorized to receive its AP security parameters prior to sharing the parameters with the STA. To help preserve STA privacy, the STA may not be required to identify itself, but the AP may still be able to detect whether or not the STA is authorized to have access to the AP security parameters prior to sharing the parameters with the STA. In addition, scanning should be as simple and fast as possible to minimize overhead (e.g., verification and temporary key setup should be rapid and, if desired, one BPE AP may respond on behalf of other BPE APs in the network). Implementations in which the STA performs active scanning are sometimes described herein as an example. In practice, passive scanning may also be used (e.g., using encryption and knowledge of the encryption at the STA).

If desired, a PASN-protected AP discovery procedure can be used to allow the STA to discover the AP (e.g., as specified by the 802.11 communication protocol governing communications between the AP and STA). The PASN-protected AP discovery procedure allows the STA to create a transient key (TK) (sometimes also referred to as temporary key TK or ephemeral key TK) that is used to protect (encrypt) management frames that are subsequently transmitted between the AP and the STA before association (e.g., the transient key may be used to protect active scanning), with or without authenticating the STA. The PASN-protected AP discovery procedure involves the STA transmitting a first PASN message (sometimes also referred to herein as PASN message 1, PASN MSG1, or simply as MSG1) that includes or otherwise identifies a Diffie-Hellman (DH) key public DHss of the STA (sometimes also referred to herein as DH public key DH_s). The AP then transmits a second PASN message (sometimes also referred to herein as PASN message 2, PASN MSG2, or simply as MSG2) that includes or otherwise identifies a DH public key DHss of the AP (sometimes also referred to herein as DH public key DH_a). The STA then transmits a third PASN message (sometimes also referred to herein as PASN message 3, PASN MSG3, or simply as MSG3) that includes or otherwise identifies a message integrity check (MIC). The STA and the AP may generate the same transient key TK (e.g., using the DH public keys DHss from the first and second PASN messages). After transmission of the third PASN message, pre-association management frames (e.g., authentication requests/responses, association requests/responses, etc.) conveyed between the AP and the STA may be protected (encrypted and decrypted) using transient key TK. Different keys than transient key TK may be used to protect associated communications during operation 408 of FIG. 4.

In some implementations, the first PASN message may include or otherwise identify a pairwise master key identifier (PMKID) that serves as a pointer to a previous association between the same STA and AP (e.g., to allow the AP to re-identify/authenticate the STA based on the previous association). In situations where the STA has not associated with the AP before, the PMKID is omitted from the first PASN message. Utilization of a PMKID in the first PASN message poses two challenges. First, the PMKID may introduce privacy issues for the STA. This is because the PMKID remains the same across all operations, such that the PMKID can be used to track the STA and AP. Second, the PMKID is created during the first authentication of the STA by the AP. For STAs that have not authenticated before, no PMKID may be available. In addition, the PMKID identifies the STA / authentication, but a scanning STA may prefer not to be identified to protect its privacy.

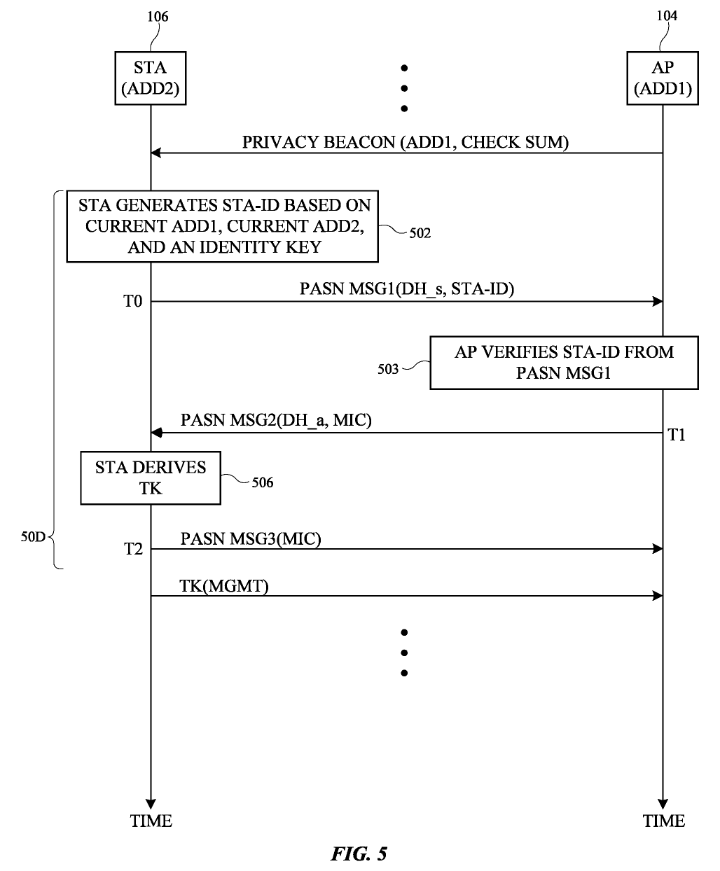

To help mitigate these issues, STA 106 may include a unique STA identifier (STA-ID) in the first PASN message transmitted to AP 104 (e.g., in addition to a PMKID or replacing the PMKID in the first PASN message). FIG. 5 is a timing diagram illustrating pre-association communications between STA 106 and AP 104 (e.g., during operation 400 of FIG. 4) that includes a PASN-protected AP scan and discovery procedure based on STA identifier STA-ID.

As shown in FIG. 5, STA 106 may have a corresponding network address ADD2 (e.g., a link-specific MAC address of STA 106) and AP 104 may have a corresponding network address ADD1 (e.g., link-specific MAC address of AP 104). Network address ADD1 may, for example, be referenced by or associated with a corresponding BSSID of AP 104. Prior to time T0, STA 106 may periodically change/anonymize the value of its network address ADD2 and AP 104 may periodically change/anonymize the value of its network address ADD1 (e.g., according to the BPE scheme implemented by the STA and AP).

Prior to time T0, AP 104 may periodically transmit privacy beacons (e.g., while processing operation 402 of FIG. 4), a most-recent of which is shown in FIG. 5. The privacy beacon may include or otherwise identify the current network address ADD1 of AP 104 (e.g., in a header field of the beacon). The privacy beacon may also include or otherwise identify a corresponding checksum (e.g., in a trailer field of the beacon). AP 104 may encrypt a payload of the privacy beacon using an AP identity key associated with the AP. The STA may have preexisting knowledge of the AP identity key (e.g., as previously shared with the STA or as preconfigured on the STA) and may use the AP identity key to decrypt the payload if desired.

The privacy beacon may, for example, have a MAC header that includes a first address field (“Address 1” or “A1”), that is followed by a second address field (“Address 2” or “A2”), which is followed by a third address field (“Address 3” or “A3”). The first address field may be set to a broadcast address (e.g., identifying the privacy beacon as a broadcast message/frame). The second address field may include or otherwise identify the network address ADD1 of AP 104 and/or the corresponding BSSID of network address ADD1. The third address field may include or otherwise identify a secure cryptographic hash value calculated based on the contents of the second address field. The value of the second address field (e.g., network address ADD1) and thus the hash in the third address field may be periodically changed/anonymized across epochs (e.g., according to the BPE scheme as specified by the 802.11 communications protocol). The privacy beacon may include a Time Synchronization Function (TSF) offset field between the MAC header and its encrypted payload (e.g., to allow synchronization maintenance with the AP). The encrypted payload may include a Change Sequence Number (CSN) field. A change in the CSN field may signal that one or more AP parameter values (e.g., AP security parameter values) of AP 104 have changed. The encrypted payload may also include a Traffic Indication Map (TIM) field (e.g., indicating whether the AP has buffered unicast or groupcast frames for the STA) and a Reduced Neighbor Report (RNR) field (e.g., as needed for maintenance of other links).

STA 106 may receive the privacy beacon from AP 104. STA 106 may use the checksum to verify the contents of the received privacy beacon. For example, if STA 106 is able to calculate the checksum included within the privacy beacon based on the value of the network address ADD1 included in the privacy beacon and the AP identity key, the STA may confirm that the AP is already known to the STA. However, the STA need not have previous knowledge of the AP to proceed with the remaining operations of FIG. 5. STA 106 may store information from the privacy beacon (e.g., at least the contents of the second address field, including the current value of network address ADD2) for subsequent processing.

Operations 500 of FIG. 5 may represent a pre-association BPE AP scan operation performed by STA 106 to scan for AP 104 (e.g., while processing operation 404 of FIG. 4). At operation 502, STA 106 may generate its STA identifier STA-ID based on the contents of the most recently received privacy beacon. For example, STA 106 may generate STA identifier STA-ID based on the current value of its own network address ADD2, the current value of the network address ADD1 of AP 104 (e.g., as identified by the A2 field of the received privacy beacon), and a corresponding cryptographic identity key.

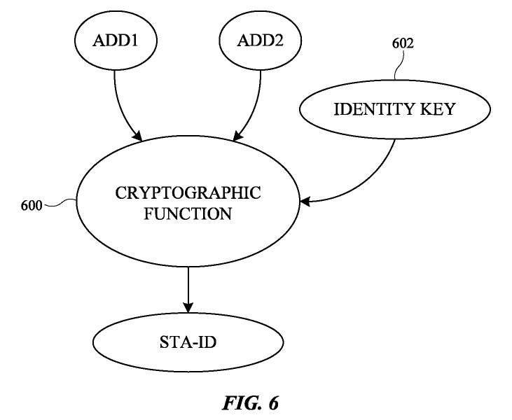

FIG. 6 illustrates one example of how STA 106 may generate STA identifier STA-ID. As shown in FIG. 6, STA 106 may include a cryptographic function 600 (e.g., implemented and/or executed using digital and/or analog logic, processor(s) 202 of FIG. 2, etc.) and a cryptographic identity key such as identity key 602 (e.g., as stored in cryptographic key storage on STA 106). Cryptographic function 600 include a hashing function/algorithm. The current network address ADD2 of STA 106 may form an input to cryptographic function 600. The current network address ADD1 of AP 104 (e.g., as identified by the most recently received privacy beacon) may form an input to cryptographic function 600. Identity key 602 (sometimes also referred to as identification key 602) may form an input to cryptographic function 600. Identity key 602 may, for example, be the AP identity key of AP 104 that was used by AP 104 to encrypt the transmitted privacy beacon. In other implementations, identity key 602 may be a STA identity key of STA 106.

Cryptographic function 600 may generate (e.g., calculate, compute, output, etc.) STA identifier STA-ID as a unique identifier (e.g., hash value) based on the current value of network address ADD2, the current value of network address ADD1, and identity key 602 (e.g., by hashing network address ADD2 with network address ADD1 and identity key 602). As one example, cryptographic function 600 may be a Hash-Based Message Authentication Code (HMAC) Secure Hash Algorithm (SHA) such as a 256-bit digest HMAC-SHA-256 function/algorithm. In this example, STA 106 may generate STA identifier STA-ID by inputting identity key 602 and a concatenation of network address ADD1 with network address ADD2 to the HMAC-SHA-256 algorithm (e.g., where STA-ID is formed from a 48-bit truncation of the output of the HMAC-SHA-256 algorithm). STA identifier STA-ID may, for example, be generated using the equation STA-ID = Truncate-48((HMAC-SHA-256(“BPE Non-AP MLD Identification,” Identity Key, ADD1|ADD2)), where “identity key” (e.g., identity key 602 of FIG. 6) is the AP identity key associated with AP 104 (e.g., a 128-bit value). STA 106 may, for example, randomly select its network address ADD2 and may subsequently transmit the first PASN message from that randomly selected network address ADD2.

If desired, a random valued sequence number SN used for the subsequent transmission of the first PASN message may also be provided as an input to cryptographic function 600 for generating STA identifier STA-ID (e.g., where STA-ID = Truncate-48((HMAC-SHA-256(“BPE Non-AP MLD Identification,” Identity Key, SN|ADD1|ADD2)). If desired, the random valued sequence number SN may be replaced with a timestamp value or a timestamp value may form an additional input to the cryptographic function. Use of the AP identity key (e.g., as identity key 602) in cryptographic function 600 may, for example, allow STA 106 to signal to AP 104 that STA 106 is authorized to receive AP security parameters from AP 104.

As another example, identity key 602 may be a STA identity key specific to STA 106 or a group of STAs that includes STA 106, instead of the AP identity key. In these implementations, the AP may store separate keys for different STAs or groups of STAs. Each STA or group of STAs that use a particular STA identity key may use that STA identity key to be identified by the AP. If desired, the AP may revoke a STA identity key when desired, such as when the corresponding STA or group of STAs is no longer authorized to receive the AP security parameters of the AP. However, use of a STA identity key may increase key storage size in the AP and STA.

Returning to FIG. 5, at time T0 (e.g., after STA 106 has generated STA identifier STA-ID), STA 106 may transmit the first PASN message (PASN MSG1) to AP 104. PASN MSG1 may include or otherwise identify a DH public key DH_s of STA 106 and may include the STA identifier STA-ID generated by STA 106. As one example, PASN MSG1 may have a first (receiver) address field (sometimes also referred to as the “Address 1” or “A1” field of PASN MSG1) that includes current network address ADD1 of AP 104, a second (transmitter) address field (sometimes also referred to as the “Address 2” or “A2” field of PASN MSG1) that includes current network address ADD2 of STA 106, and a third (BSSID) address field (sometimes also referred to as “Address 3” or “A3” field of PASN MSG1) that includes the current network address ADD1 of AP 104 (e.g., corresponding to a particular BSSID of the AP).

AP 104 may receive the first PASN message and may verify/authenticate STA 106 based on the STA identifier STA-ID included in the first PASN message. AP 104 may, for example, generate a candidate (test) STA identifier STA-ID’ for STA 106 based on its current address ADD1, the current address ADD2 of STA 106 (e.g., as identified or included within a header field of PASN MSG1), identity key 602 (e.g., the AP identity key or STA identity key, which are both known to AP 104), and optionally the random value sequence number SN included within or identified by PASN MSG1 (e.g., by performing the same cryptographic operation as STA 106, shown in FIG. 6). AP 104 may successfully verify/authenticate STA 106 if/when the candidate STA identifier STA-ID’ calculated at AP 104 matches the STA identifier STA-ID included in PASN MSG1, indicating that STA 106 is authorized to receive the AP security parameters of AP 104. The verification/authentication may be unsuccessful (fail) if/when the candidate STA identifier STA-ID’ calculated at AP 104 does not match the STA identifier STA-ID included in PASN MSG1, indicating that STA 106 is not authorized to receive the AP security parameters of AP 104. If/when AP 104 successfully verifies STA 106, processing may proceed to the remaining operations of FIG. 5. If/when AP 104 is unable to verify STA 106, processing may end.

In this way, STA identifier STA-ID may be generated and utilized by both STA 106 and AP 104 to indicate whether STA 106 is allowed to obtain the AP security parameters of AP 104. At the same time, STA identifier STA-ID may not directly indicate the identity of STA 106, helping to preserve privacy of the STA. The AP may rapidly verify STA 106 using just a single hashing function (e.g., a single iteration of cryptographic function 600), where PASN is continued only when STA identifier STA-ID is successfully verified. In addition, the particular value of STA identifier STA-ID is valid only for a single-time use because the network address ADD1 of AP 104 and the network address ADD2 of STA 106 changes for every epoch under the BPE scheme (e.g., at least STA 106 may change the value of its network address ADD2 prior to or at the beginning of each BPE AP scan operation performed by the STA).

In implementations where the AP identity key is used to generate STA identifier STA-ID, STA 106 uses the AP identity key (sometimes also referred to as an AP identification key) to signal to AP 104 that STA 106 is authorized/allowed to receive PASN-protected AP security parameter information. If desired, the secure hash in PASN MSG1 (e.g., as used to generate STA identifier STA-ID) may serve to verify that AP information has been pre-shared with STA 106. The AP identity key may be stored at STA 106 in any case, requiring no additional memory consumption at the STA or AP. The AP does not need to identify the particular STA that transmitted PASN MSG1 (sometimes also referred to herein as a PASN query), instead only needing to compute a single hash value to determine whether the STA that transmitted PASN MSG1 is authorized to use the network. If desired, the AP identity key may be reused, although reusing the AP identity key may increase the attack surface to the key.

In response to successfully verifying STA identifier STA-ID, AP 104 may transmit the second PASN message (PASN MSG2) to STA 106. PASN MSG2 may include or otherwise identify a DH public key DH_a of AP 104 and a corresponding message integrity check MIC. STA 106 may receive the second PASN message. At operation 506 (e.g., at or after time T1), STA 106 may derive (e.g., calculate, compute, produce, output, generate, identify, etc.) the transient key TK used to encrypt/decrypt subsequent management frames conveyed between STA 106 and AP 104 prior to association (e.g., based on its DH public key DH_s and the DH public key DH_a included in PASN MSG2). If desired, AP 104 may also derive the same transient key TK based on the DH public key DH_s of STA 106 included in PASN MSG1 and its DH public key DH_a (e.g., at or after time T0, concurrent with operation 506, after time T1, etc.) for use in encrypting/decrypting subsequent management frames conveyed between STA 106 and AP 104 prior to association.

At time T2, STA 106 may transmit the third PASN message (PASN MSG3) to AP 104. PASN MSG3 may include or otherwise identify the message integrity check (MIC). After transmission of PASN MSG3, the transient key TK shared by STA 106 and AP 104 may be used to encrypt and decrypt management frames MGMT conveyed between STA 106 and AP 104 (e.g., authentication requests, authentication responses, AP security parameter requests, AP security parameter responses, association requests, association responses, etc.).

In this way, the PASN procedure may serve as a Diffie-Hellman key exchange that creates a shared secret (e.g., transient key TK) possessed by both STA 106 and AP 104 for conveying protected pre-association management frames MGMT. In a DH key exchange, a first entity (e.g., STA 106) and a second entity (e.g., AP 104) agree on public parameters, the first entity combines their own secret key (a first secret key) with the public parameters to produce a corresponding first public key (e.g., DH public key DH_s) that is then transmitted to the second entity, the second entity combines their own secret key (a second secret key) with the public parameters to produce a corresponding second public key (e.g., DH public key DH_a) that is then transmitted to the first entity, the first entity then combines the received second public key with their first secret key to produce a secret value, and the second entity combines the received first public key with their second secret key to produce the same secret value, where the secret value serves as a shared secret (e.g., transient key TK) that is used to encrypt/decrypt subsequent messages (e.g., management frames MGMT) between the first and second entities.

The DH key exchange implemented by the PASN scheme of FIG. 5 creates a transient key TK only between the AP and a real/verified STA (e.g., preventing a man-in-the-middle (MITM) attacker from being able to derive the transient key). STA identifier STA-ID may allow replay of a frame by an attacker. However, even if the first PASN message is replayed by an attacker, the following frames are encrypted and the attacker cannot derive transient key TK. Because the AP changes its network address ADD1 periodically under the BPE scheme and STA 106 changes its network address ADD2 for every scan (e.g., for every iteration of operations 500 or operation 404 of FIG. 4), the potential for STA-ID replay tracking is limited.

As one example, the management frames MGMT encrypted by transient key TK may include an AP security parameter request (query) transmitted by the STA to the AP and an AP security parameter response transmitted by the AP to the STA. In this example, the STA may encrypt the AP security parameter request using transient key TK. The AP may use transient key TK to decrypt the parameter request. The AP may then transmit an AP security parameter response responsive to receipt of the AP security parameter request. The AP security parameter response may include the AP security parameters needed by STA 106 to successfully associate with AP 104. The AP may encrypt the AP security parameter response using transient key TK. The STA may use transient key TK to decrypt the AP security parameter response. The MIC of the third PASN message may help to ensure that the correct transient key TK is derived for these management frames. However, this type of AP security parameter query is overhead intensive, requiring at least five different messages to be exchanged between the AP and STA. In addition, the STA cannot scan multiple channels in parallel and exhibits increased power consumption. It would therefore be desirable to be able to increase the speed and flexibility with which the STA uses the PASN scheme to scan for the AP.

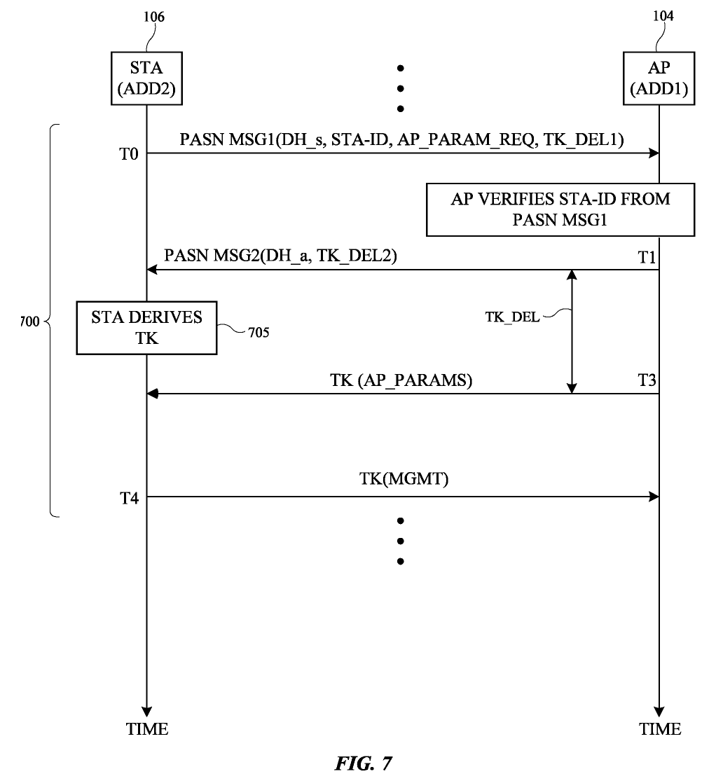

To help mitigate these issues, the STA may signal that it is needs the AP security parameters of AP 104 using PASN MSG1 (e.g., in scenarios where STA 106 has no preconfigured knowledge of the AP parameters) and AP 104 may transmit the AP security parameters, encrypted using transient key TK, to STA 106 prior to transmission of PASN MSG3 by STA 106 or instead of transmission of PASN MSG3 by STA 106. FIG. 7 is a timing diagram illustrating one such example, beginning at time T0. The operations of FIG. 5 prior to time T0 have been omitted from FIG. 7 for the sake of clarity.

As shown in FIG. 7, in addition to DH public key DH_s and STA identifier STA-ID, the PASN MSG1 transmitted by STA 106 may include an AP security parameter request AP_PARAM_REQ (sometimes also referred to herein as an AP security parameter request tag, field, flag, or bit). AP security parameter request AP_PARAM_REQ may signal to AP 104 that STA 106 does not have knowledge of the AP security parameters required for STA 106 to associate with AP 104. AP security parameter request AP_PARAM_REQ may, for example, have a first value (e.g., a single bit value set to binary “1”) if/when STA 106 does not have knowledge of the AP security parameters and/or if/when STA 106 is requesting that AP 104 transmit its AP security parameters to STA 106. On the other hand, AP security parameter request AP_PARAM_REQ may have a second value (e.g., a single bit value set to binary “0”) if/when STA 106 already has knowledge of the AP security parameters and/or if/when STA 106 is not requesting that AP 104 transmit its AP security parameters to STA 106. In this way, AP security parameter request AP_PARAM_REQ may serve as a trigger or query for the transmission of AP security parameters by AP 104.

If desired, the PASN MSG1 transmitted by STA 106 may also include a transient key adoption delay request TK_DEL1 (sometimes also referred to herein as a TK adoption delay tag, field, or flag). Transient key adoption delay request TK_DEL1 may, for example, inform AP 104 of an amount of time or delay required by STA 106 to generate or adopt transient key TK. At operation 702 (e.g., responsive to receipt of PASN MSG1), AP 104 may verify the STA identifier STA-ID from PASN MSG1 (e.g., similar to operation 504 of FIG. 5). AP 104 may also begin deriving transient key TK. In practice, AP 104 may require a non-zero amount of time or delay to generate or adopt transient key TK (e.g., the same amount of time as required by STA 106 or a different amount of time).

The PASN MSG2 transmitted by AP 104 at time T1 may include a transient key adoption delay request TK_DEL2 (sometimes also referred to herein as a TK adoption delay tag, field, or flag). Transient key adoption delay request TK_DEL2 may, for example, inform STA 106 of an amount of time or delay required by AP 104 to generate or adopt transient key TK. At operation 705 (e.g., responsive to receipt of PASN MSG2), STA 106 may begin deriving transient key TK (e.g., similar to operation 506 of FIG. 5).

At time T3, responsive to AP security parameter request AP_PARAM_REQ having the first value indicative of STA 106 requesting AP security parameters from AP 104, AP 104 may transmit its AP security parameters AP_PARAMS to STA 106 (sometimes also referred to herein as AP security parameter message AP_PARAMS or AP security parameter frame AP_PARAMS). AP 104 may encrypt AP security parameters AP_PARAMS (e.g., in an encrypted payload of an AP security parameter message or frame) using transient key TK. As one example, AP 104 may transmit a MAC management protocol data unit (MMPDU) that contains AP security parameters AP_PARAMS that have been encrypted using transient key TK.

If desired, AP 104 may delay transmission of AP security parameters AP_PARAMS by TK adoption delay period TK_DEL (e.g., the time period between times T1 and T3). TK adoption delay period TK_DEL may be a minimum duration between PASN MSG2 and transmission of transient key-encrypted frames between STA 106 and PA 104. If desired, AP 104 may select TK adoption delay period TK_DEL based on the transient key delay request TK_DEL2 included in PASN MSG2 and the transient key delay request TK_DEL1 received in PASN MSG1. For example, AP 104 may select TK adoption delay period TK_DEL to be long enough to allow STA 106 sufficient time to derive transient key TK (e.g., based on the transient key adoption delay request TK_DEL1 received from STA 106 in PASN MSG1) and to allow AP 104 sufficient time to derive transient key TK. Alternatively, TK adoption delay period TK_DEL may be specified or set by the 802.11 communications protocol (e.g., to a period long enough to support transient key adoption for the wide majority of potential STA implementations). AP 104 may forego transmission of AP security parameters AP_PARAMS if/when the AP security parameter request AP_PARAM_REQ in PASN MSG1 has the second value, indicative of STA 106 already having knowledge of the AP security parameters of AP 104.

At time T4, STA 106 has had sufficient time to adopt transient key TK for use in encrypting subsequent management frames MGMT. STA 106 may proceed to convey management frames MGMT with AP 104 that are encrypted and decrypted using transient key TK. The transmission of a PASN MSG3 including a MIC (see, e.g., FIG. 5) may be omitted in this implementation. If desired, if/when AP 104 does receive a PASN MSG 3 (FIG. 5) from STA 106, AP 104 may forego waiting for TK adoption delay period TK_DEL to elapse and may instead immediately transmit the TK-encrypted AP security parameters AP_PARAMS responsive to receipt of a satisfactory MIC in PASN MSG3. The TK adoption delay period TK_DEL configured by AP 104 may, for example, allow the AP to skip one or more transmit opportunities (TXOPs) in the active scanning procedure. This may serve to reduce response time and channel contention.

As one example, STA 106 may transmit PASN MSG1 during a first TXOP. AP 104 may then transmit PASN MSG2 during a second TXOP (e.g., the next TXOP after the first TXOP). Depending on the length of TK adoption delay period TK_DEL, AP 104 may transmit the TK-encrypted AP security parameters AP_PARAMS within the second TXOP or within a third TXOP (e.g., the next TXOP after the second TXOP). In implementations where the AP security parameters are transmitted in the second TXOP, STA 106 is able to receive the AP security parameters from AP 104 within only two TXOPs, minimizing the time required for STA 106 to associate with AP 104. By delaying transmission of the AP security parameters to the third TXOP (e.g., through suitable configuration of TK adoption delay period TK_DEL), AP 104 may help to accommodate STAs that have hardware that is unable to immediately decrypt the AP parameters because the transient key TK has not yet been installed.

Querying and delivering protected AP security parameters to STA 106 in this way may be much faster than transmitting a TK-protected AP security parameter request and a TK-protected AP security parameter response after transmission of PASN MSG3, requires less overhead (e.g., because PASN MSG3 be omitted from the PASN procedure, as shown in FIG. 7), and may allow the STA to concurrently scan over other APs or save power (e.g., in a radio-off or sleep state) during TK adoption delay period TK_DEL. If desired, this scanning transmission order may also be used in AP scanning implementations based on a PMKID (e.g., where the PMKID identifies the STA and PASN protects the response).

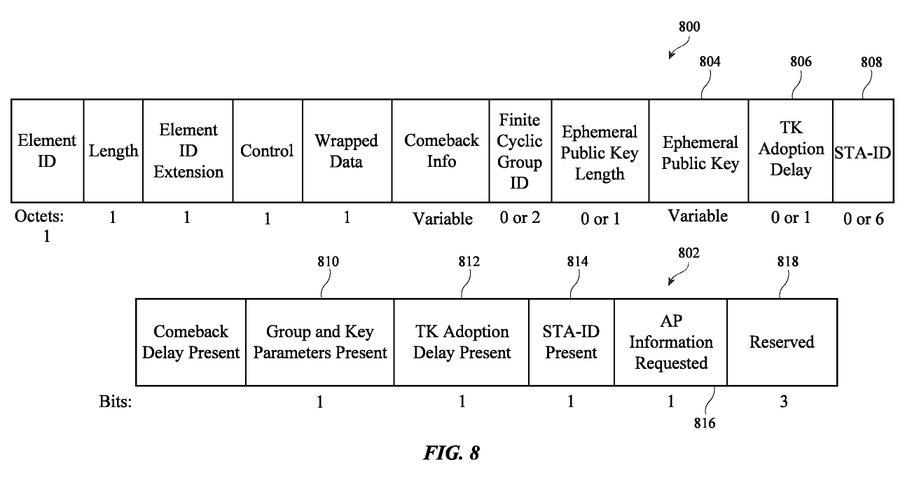

FIG. 8 is a diagram showing two examples of PASN message payloads that may be included in the PASN MSG1 and/or PASN MSG2 transmitted by STA 106 and/or AP 104. Portion 800 of FIG. 8 illustrates different fields of the PASN message payload in a PASN parameters element format (with corresponding field lengths in Octets). Portion 802 of FIG. 8 illustrates a portion of the PASN message payload in a PASN parameters element Control Information Field format (with corresponding field lengths in bits).

As shown by portion 800 of FIG. 8, the PASN message payload may include an element identifier (ID) field followed by a length field, followed by an element ID extension field, followed by a control field, followed by a wrapped data field, followed by a variable-length comeback information field, followed by a finite cyclic group identifier (ID) field, followed by an ephemeral public key length field, followed by an ephemeral public key field 804, followed by a TK adoption delay field 806, followed by a STA identifier field 808 (e.g., TK adoption delay field 806 may be between ephemeral public key field 804 and STA identifier field 808). This is illustrative and, if desired, the fields may be in other orders, one or more of these fields may be omitted, and/or additional fields may be included in the PASN message payload.

TK adoption delay field 806 may include or otherwise identify the transient key adoption delay request TK_DEL1 (FIG. 7) transmitted by STA 106 within PASN MSG1. If desired, AP 104 may use information within TK adoption delay field 806 to generate the TK adoption delay period TK_DEL between PASN MSG2 transmission and TK-encrypted frame transmission. If desired, STA 106 may set TK adoption delay field 806 to zero (null) or may omit TK adoption delay field 806 if/when STA 106 does not require a TK adoption delay period to install transient key TK (e.g., AP 104 may transmit AP security parameters AP_PARAMS within the same TXOP as PASN MSG2 responsive to TK adoption delay field 806 having a null value or being omitted from PASN MSG1 and may transmit AP security parameters AP_PARAMS after TK adoption delay period TK_DEL responsive to TK adoption delay field 806 having a non-zero value). STA identifier field 808 may include the STA identifier STA-ID generated by STA 106 (e.g., in PASN MSG1). AP 104 may use the contents of STA identifier field 808 to verify STA 106 (e.g., at operation 504 of FIG. 5 or operation 702 of FIG. 7).

As shown by portion 802 of FIG. 8, the PASN message payload may include a comeback delay present field, followed by a group and key parameters present field 810, followed by a TK adoption delay present field 812, followed by a STA-ID present field 814, followed by AP information requested field 816, followed by a reserved field 818 (e.g., TK adoption delay present field 812 may be between fields 810 and 814, field 814 may be between fields 812 and 802, and field 802 may be between fields 814 and 818). This is illustrative and, if desired, the fields may be in other orders, one or more of these fields may be omitted, and/or additional fields may be included in the PASN message payload.

TK adoption delay present field 812 may indicate whether the PASN MSG includes or otherwise identifies a TK adoption delay period TK_DEL. Field 812 may, for example, have a first value such as binary “1” when a TK adoption delay period TK_DEL is present and may have a second value such as binary “0” when no TK adoption delay period TK_DEL is present in the PASN MSG. If desired, AP 104 may transmit AP security parameters AP_PARAMS within the same TXOP as PASN MSG2 responsive to field 812 having the second value and may transmit AP security parameters AP_PARAMS after TK adoption delay period TK_DEL responsive to field 812 having the first value.

STA-ID present field 814 may indicate whether the PASN MSG includes or otherwise identifies a STA identifier STA-ID generated by STA 106. Field 814 may, for example, have a first value such as binary “1” when a STA identifier STA-ID is present and may have a second value such as binary “0” when no STA identifiers STA-ID are present in the PASN MSG. AP 104 may, for example, search for a STA identifier STA-ID (e.g., in field 808 of FIG. 8) and may use that STA identifier to verify the STA responsive to field 814 having the first value and may forego these operations responsive to field 814 having the second value.

AP information requested field 816 may serve as the AP security parameter request AP_PARAM_REQ in PASN MSG1 of FIG. 7. AP information requested field 816 may indicate whether the transmitting STA needs or is requesting protected transmission of the AP security parameters of AP 104. Field 816 may, for example, have a first value such as binary “1” when STA 106 does not have knowledge of the AP security parameters AP_PARAMS (FIG. 7) needed to associate with AP 104, when STA 106 is requesting protected transmission of AP security parameters AP_PARAMS from AP 104, and/or when STA 106 otherwise needs AP security parameters AP_PARAMS from AP 104. Field 816 may have a second value such as binary “0” when STA 106 already has knowledge of the AP security parameters AP_PARAMS needed to associate with AP 104, when STA 106 is not requesting transmission of AP security parameters AP_PARAMS from AP 104, and/or when STA 106 does not otherwise need AP security parameters AP_PARAMS from AP 104. AP 104 may, for example, forego TK-protected transmission of AP security parameters AP_PARAMS responsive to field 816 having the second value and may perform TK-protected transmission of AP security parameters AP_PARAMs (e.g., at time T3 of FIG. 7) responsive to field 816 having the first value.

As a non-limiting example, STA 106 may include a RSNE to the PASN authentication frames with either of the following settings: (1) if the STA-ID subfield of PASN Parameters element is present, then RSNE has no PMKID field present, AKM Suite Count field is set to 0, and Pairwise Cipher field is set to Galois Counter Mode Protection (GCMP)-256, and/or (2) if no STA-ID subfield of PASN Parameters element is present, then the RSNE has the PMKID field present, and the AKM field and Pairwise Cipher field are set to the values that were used to calculate the PMKID. The STA-ID field in the PASN Parameters element of the first PASN authentication frame, when present, may indicate whether the transmitter is allowed to setup a transient key TK with the BPE AP (e.g., AP 104).

The STA identifier calculation may, for example, be given by the equation STA-ID = Truncate-48(HMAC-SHA-256(“BPE Non-AP MLD identification”, Identity Key, Address1|Address 2)), where Identity Key is 128-bit identifier of the AP MLD, Address1 is the A1 of the PASN authentication frame and it is set to the link address of the BPE AP, and Address2 is the A2 of the PASN authentication frame and it is set to a link address of the STA. The STA may use randomize and change the Address2 for each BPE active scanning operation. If a BPE AP receives a first PASN authentication frame with a STA-ID, then the BPE AP may respond with a PASN authentication frame. If the BPE AP can calculate a STA identifier from the Address1 and Address2 of the received PASN frame, and the calculated STA identifier STA-ID is equal to the value of the STA-ID field of the received PASN authentication frame.

If desired, STA 106 may set the AP Information Requested subfield of the PASN element of the first PASN authentication frame to indicate that the STA desires to receive an AP Capabilities And Operation Parameters Response frame with a complete set of AP MLD parameters. If this subfield is set to a value 1, then the first PASN authentication frame (e.g., PASN MSG1) may include a TK Adoption Delay subfield set to a duration the STA needs to take the TK into use after the PASN authentication frame 2. If AP 104 receives such a first PASN authentication frame and the STA-ID field matches, then the BPE AP may respond with a second PASN authentication frame (e.g., PASN MSG2). The second PASN authentication frame may contain a TK Adoption Delay field, if the responding AP TK adoption delay is longer than the TK adoption delay of the requesting STA. The AP may transmit a TK protected AP capabilities and operations response frame the largest TK adoption delay value after the second PASN authentication frame transmission. If the STA desires to continue TK protected management frames transmissions with the BPE AP, the STA may transmit any TK encrypted frame or a third PASN authentication frame (e.g., PASN MSG3). The STA may transmit the TK encrypted frame after the largest TK adoption delay value after the second PASN authentication frame transmission.

In FIG. 8, the Comeback Info Present subfield may indicate whether the Comeback Info field is included in the PASN Parameters element. The Group and Key Present subfield may indicate whether the PASN Parameters element includes the Finite Cyclic Group ID, the Ephemeral Public Key Length, and the Ephemeral Public Key fields. The TK Adoption Delay Present subfield may indicates whether the TK Adoption Delay field is included in the PASN Parameters element. The STA-ID Present subfield may indicate whether the STA-ID field is included in the PASN Parameters element. The AP Info Requested subfield may indicate whether the AP capabilities and operations information is requested. The TK Adoption Delay field may be the time in units of 64 microseconds after the second PASN authentication frame after which the TK protected frames can be transmitted, as one example. The STA-ID field may be an identifier of the BPE non-AP STA. The example of FIG. 8 is illustrative and, in general, the fields may be in other orders in the payload, the payload may include different/additional fields, and/or one or more of the fields shown in FIG. 8 may be omitted.

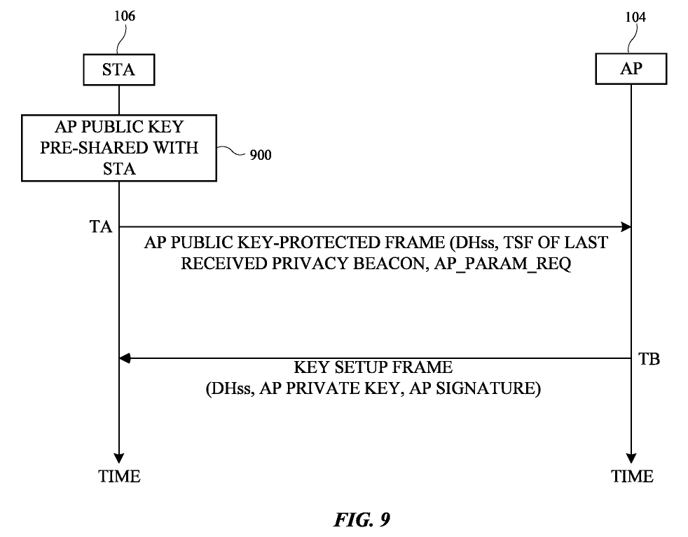

In another implementation, STA 106 may perform protected BPE AP scanning using the AP public key of AP 104 (e.g., the same public key used by the AP to encrypt the payload of the privacy beacon). FIG. 9 is a timing diagram showing one example of how STA 106 may perform protected BPE AP scanning using the AP public key of AP 104. The operations of FIG. 9 may occur after receipt of a privacy beacon from AP 104. This may occur, for example, when STA 106 has knowledge of the AP public key (e.g., via preconfiguration or sharing at operation 900) to set up a new set of keys. At time TA, STA 106 may transmit a frame that is encrypted (protected) using the AP public key. The AP public key-protected frame may include or otherwise identify a DH public key DHss of STA 106, a TSF of the most recently received privacy beacon, and AP security parameter request AP_PARAM_REQ. At time TB (e.g., responsive to receipt of the AP public key-protected frame), AP 104 may transmit a key setup frame to STA 106. The key setup frame (e.g., a clear frame) may include or otherwise identify a DH public key DHss of AP 104, an AP private key of AP 104 (e.g., corresponding to the AP public key), and/or an AP signature.

In these implementations, only pre-shared STAs have knowledge of the AP public key. The AP assumes that any correctly received AP public key-protected frame was transmitted by a valid (authentic) STA. The STA may add the TSF of the last received privacy beacon to the AP public key-protected frame to avoid replays. The pre-shared STA may use the AP public key to protect a request to set up a symmetric key (e.g., the AP private key) for use during pre-association signaling. The AP may send a DH ephemeral public key (e.g., the DH public key DHss transmitted at time TB) for pairwise transient key (PTK) creation in a frame (clear frame). The same TXOP may also include PTK-encrypted AP security parameters AP_PARAMS if desired. Separate PPDUs may be needed to have current PPDU types (e.g., clear or encrypted).

Whereas the 802.11bi protocol and/or earlier protocols assume that BPE AP security parameters required to authenticate and associate a STA with a BPE AP (e.g., RSNE, RSNXE, etc.) are pre-shared to the STA prior to operation 400 of FIG. 4, by utilizing the systems and methods of one or more of FIGS. 1-9 as described herein, PASN TK protected AP capabilities and operations elements may be provided that allow AP 104 to securely provide its BPE AP security parameters to STA 106. The corresponding PASN signaling as described herein may allow the AP to check whether the requesting STA 106 is allowed to receive the AP security parameters prior to transmitting the AP security parameters to the STA in a protected manner.

The TK-protected AP security parameter query described herein may provide several benefits over pre-sharing the AP security parameters with a STA. For example, only the AP identity key and a master key may need to be shared with STA 106 prior to operation 400 of FIG. 4. This may help to reduce memory consumption at the STA. As another example, AP 104 may simply and rapidly verify whether STA 106 is authorized to receive its AP security parameters (e.g., without specifically identifying STA 106 to the AP). This may help to prevent the AP security parameters from leaking to a potential attacker. As another example, the privacy of the scanning STA 106 may be improved, helping to prevent scan request parameters from leaking to third devices. As yet another example, RSNE and RSNXE mismatch between the STA and the AP may not prevent authentication on its own and the STA may optimize association via knowledge of available links and AP parameters. As a further example, the AP security parameters may be integrity protected, allowing the requesting STA to verify the integrity of the received AP security parameters. The protected scanning optimizations may also reduce the number of transmitted frames and scanning delays, helping to reduce time and resources required to associate with the AP in a secure manner.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” The term “when” also implies at least some concurrency (e.g., event A occurring “when” event B occurs means that at least some of event A is concurrent with at least some of event B).

STAs 106 and APs 102/104 (FIG. 1) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-19 may be performed by the components of a STA and/or AP using software, firmware, and/or hardware (e.g., dedicated circuitry or hardware). Software code for performing these operations may be stored on non-transitory computer readable storage media (e.g., tangible computer readable storage media) stored on one or more of the components of the STA and/or AP. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the STA and/or AP. The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth in the example section below. For example, circuitry associated with an electronic device, authentication server, one or more processors, etc. as described above in connection with one or more of the preceding figures may be configured to operate in accordance with one or more of the examples set forth below in the example section.

### Examples

In the following sections, further exemplary aspects are provided.

Example 1 includes a method of operating a station (STA) to communicate with an access point (AP). The method can include generating, using one or more processors, a station identifier (STA-ID) based on a first network address of the AP, a second network address of the STA, a cryptographic key, and a cryptographic function. The method can include transmitting, using one or more antennas, the STA-ID to the AP in a first message. The method can include receiving, using the one or more antennas, a second message that is transmitted by the AP based on the STA-ID in the first message. The method can include associating with the AP using one or more encrypted management frames conveyed between the STA and the AP after receipt of the second message.

Example 2 includes the method of example 1 or some other example or combination of examples herein, further comprising: receiving, from the AP, a privacy beacon prior to transmission of the first message, wherein the privacy beacon identifies the first network address.

Example 3 includes the method of any of examples 1 or 2 or some other example or combination of examples herein, wherein at least some of the privacy beacon is encrypted by the AP using a public key of the AP and wherein the cryptographic key comprises the public key of the AP.

Example 4 includes the method of any of examples 1-3 or some other example or combination of examples herein, wherein the first address comprises a first media access control (MAC) address of the AP and the second address comprises a second MAC address of the STA.

Example 5 includes the method of any of examples 1-4 or some other example or combination of examples herein, wherein the cryptographic function comprises a secure hash algorithm (SHA) and generating the STA-ID comprises inputting the first MAC address, the second MAC address, and the public key of the AP to the SHA.

Example 6 includes the method of any of examples 1-5 or some other example or combination of examples herein, wherein the first message comprises a Pre-Association Security Negotiation (PASN) message 1 (MSG1) and the second message comprises a PASN message 2 (MSG2).

Example 7 includes the method of any of examples 1-6 or some other example or combination of examples herein, wherein the PASN MSG1 comprises a first Diffie-Hellman (DH) public key of the STA and the PASN MSG2 comprises a second DH public key of the AP, the method further comprising: generating, using the one or more processors, a transient key (TK) based on the first DH public key and the second DH public key; and encrypting, using the one or more processors, at least one of the one or more encrypted management frames based on the TK.

Example 8 includes the method of any of examples 1-7 or some other example or combination of examples herein, wherein the PASN MSG2 comprises a message integrity check (MIC), the method further comprising: transmitting, using the one or more antennas, a PASN message 3 (MSG3) that includes the MIC.

Example 9 includes the method of any of examples 1-48 or some other example or combination of examples herein, wherein the PASN MSG1 comprises a field that identifies whether the STA is requesting a set of AP security parameters from the AP for use in associating with the AP.

Example 10 includes the method of any of examples 1-9 or some other example or combination of examples herein, further comprising: deriving, using the one or more processors, a transient key (TK) based at least on the PASN MSG2 received from the AP; receiving, using the one or more antennas after receipt of the PASN MSG2, a third message containing the set of AP security parameters; decrypting, using the TK, the third message; and associating with the AP based on the set of AP security parameters from the decrypted third message.

Example 11 includes the method of any of examples 1-10 or some other example or combination of examples herein, wherein the set of AP security parameters comprises a Robust Security Network Element (RSNE) of the AP and a Robust Security Network Extension Element (RSNXE) of the AP.

Example 12 includes the method of any of examples 1-11 or some other example or combination of examples herein, wherein the PASN MSG1 comprises a field that identifies a transient key adoption delay of the STA and wherein the third message is received from the AP after a time period has elapsed since receipt of the PASN MSG2, wherein the time period is greater than or equal to the transient key adoption delay of the STA.

Example 13 includes the method of any of examples 1-12 or some other example or combination of examples herein, wherein the PASN MSG2 comprises a field that identifies a transient key adoption delay of the AP and wherein the third message is received from the AP after a time period has elapsed since receipt of the PASN MSG2, wherein the time period is greater than or equal to the transient key adoption delay of the AP.

Example 14 includes a method of operating an access point (AP) to communicate with a station (STA), the method comprising: transmitting, using one or more antennas, a privacy beacon that is encrypted using a cryptographic key of the AP; receiving, using one or more antennas, a first message from the STA that includes a station identifier (STA-ID); attempting to verify, using one or more processors, the STA-ID in the first message based on a first network address of the AP, a second network address of the STA, the cryptographic key, and a cryptographic function; and transmitting, using the one of more antennas responsive to verifying the STA-ID, a second message to the STA, the second message comprising information usable by the STA to encrypt a management frame used in associating the STA with the AP.

Example 15 includes the method of example 14 or some other example or combination of examples herein, wherein attempting to verify the STA-ID comprises inputting the first network address, the second network address, and the cryptographic key to the cryptographic function and comparing an output of the cryptographic function to the STA-ID in the first message.

Example 16 includes the method of any of examples 14 or 15 or some other example or combination of examples herein, wherein the first message comprises a Pre-Association Security Negotiation (PASN) message 1 (MSG1) and the second message comprises a PASN message 2 (MSG2).

Example 17 includes the method of any of examples 14-16 or some other example or combination of examples herein, wherein the PASN message 1 comprises an AP security parameter request and a first transient key adoption delay, the PASN message 2 comprises a second transient key adoption delay, and the method further comprises: transmitting, using the one or more antennas after transmission of the PASN MSG2 and prior to the STA associating with the AP, a set of AP security parameters to the STA, wherein the set of AP security parameters are encrypted using a transient key derived by the AP based at least in part on the PASN MSG1, the AP transmits the set of AP security parameters after a time period has elapsed from transmission of the PASN MSG2, and the time period is longer than a larger of the first transient key adoption delay and the second transient key adoption delay.

Example 18 includes a method of operating a station (STA) to communicate with an access point (AP), the method comprising: transmitting, using a radio and one or more antennas communicatively coupled to the radio, a Pre-Association Security Negotiation (PASN) message to the AP, wherein the PASN message includes a payload that comprises: a STA identifier (STA-ID) field, the STA-ID field including a STA-ID usable by the AP to verify that the STA is authorized to receive a set of security parameters from the AP; and associating, using the radio, with the AP based on the set of security parameters.

Example 19 includes the method of example 18 or some other example or combination of examples herein, wherein the payload of the PASN message further comprises: a transient key (TK) adoption delay field; a TK adoption delay present field corresponding to the TK adoption delay field; a STA-ID present field corresponding to the STA-ID field; and an AP information requested field.

Example 20 includes the method of any of example 18 or 19 or some other example or combination of examples herein, wherein: the TK adoption delay field and the STA-ID field are in a PASN parameters element format, the TK adoption delay field is between the STA-ID field and an ephemeral public key field of the payload, the ephemeral public key field is in the PASN parameters element format, the TK adoption delay present field, the STA-ID present field, and the AP information requested field are in a PASN parameters element control information field format, and the STA-ID present field is between the TK adoption delay present field and the AP information requested field of the payload.

Example 21 may include an apparatus comprising means to perform one or more elements of a method described in or related to any of examples 1-20 or any combination thereof, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20 or any combination thereof, or any other method or process described herein.

Example 23 may include an apparatus comprising logic, modules, or circuitry to perform one or more elements of a method described in or related to any of examples 1-20 or any combination thereof, or any other method or process described herein.

Example 24 may include a method, technique, or process as described in or related to any of examples 1-20 or any combination thereof, or portions or parts thereof.

Example 25 may include an apparatus comprising: one or more processors and one or more non-transitory computer-readable storage media comprising instructions that, when executed by the one or more processors, cause the one or more processors to perform the method, techniques, or process as described in or related to any of examples 1-20, or any combination thereof, or portions thereof.

Example 26 may include a signal as described in or related to any of examples 1-20, or any combination thereof, or portions or parts thereof.

Example 27 may include a datagram, information element, packet, frame, segment, PDU, or message as described in or related to any of examples 1-20, or any combination thereof, or portions or parts thereof, or otherwise described in the present disclosure.

Example 28 may include a signal encoded with data as described in or related to any of examples 1-20, or any combination thereof, or portions or parts thereof, or otherwise described in the present disclosure.

Example 29 may include a signal encoded with a datagram, IE, packet, frame, segment, PDU, or message as described in or related to any of examples 1-20, or any combination thereof, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or any combination thereof, or portions thereof.

Example 31 may include a computer program comprising instructions, wherein execution of the program by a processing element is to cause the processing element to carry out the method, techniques, or process as described in or related to any of examples 1-20, or any combination thereof, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

What is claimed is:

1. A method of operating a station (STA) to communicate with an access point (AP), the method comprising:
generating, using one or more processors, a station identifier (STA-ID) based on a first network address of the AP, a second network address of the STA, a cryptographic key, and a cryptographic function;
transmitting, using one or more antennas, the STA-ID to the AP in a first message;
receiving, using the one or more antennas, a second message that is transmitted by the AP based on the STA-ID in the first message; and
associating with the AP using one or more encrypted management frames conveyed between the STA and the AP after receipt of the second message.

2. The method of claim 1, further comprising:
receiving, from the AP, a privacy beacon prior to transmission of the first message, wherein the privacy beacon identifies the first network address.

3. The method of claim 2, wherein at least some of the privacy beacon is encrypted by the AP using a public key of the AP and wherein the cryptographic key comprises the public key of the AP.

4. The method of claim 3, wherein the first address comprises a first media access control (MAC) address of the AP and the second address comprises a second MAC address of the STA.

5. The method of claim 4, wherein the cryptographic function comprises a secure hash algorithm (SHA) and generating the STA-ID comprises inputting the first MAC address, the second MAC address, and the public key of the AP to the SHA.

6. The method of claim 1, wherein the first message comprises a Pre-Association Security Negotiation (PASN) message 1 (MSG1) and the second message comprises a PASN message 2 (MSG2).

7. The method of claim 6, wherein the PASN MSG1 comprises a first Diffie-Hellman (DH) public key of the STA and the PASN MSG2 comprises a second DH public key of the AP, the method further comprising:
generating, using the one or more processors, a transient key (TK) based on the first DH public key and the second DH public key; and
encrypting, using the one or more processors, at least one of the one or more encrypted management frames based on the TK.

8. The method of claim 6, wherein the PASN MSG2 comprises a message integrity check (MIC), the method further comprising:
transmitting, using the one or more antennas, a PASN message 3 (MSG3) that includes the MIC.

9. The method of claim 6, wherein the PASN MSG1 comprises a field that identifies whether the STA is requesting a set of AP security parameters from the AP for use in associating with the AP.

10. The method of claim 9, further comprising:
deriving, using the one or more processors, a transient key (TK) based at least on the PASN MSG2 received from the AP;
receiving, using the one or more antennas after receipt of the PASN MSG2, a third message containing the set of AP security parameters;
decrypting, using the TK, the third message; and
associating with the AP based on the set of AP security parameters from the decrypted third message.

11. The method of claim 10, wherein the set of AP security parameters comprises a Robust Security Network Element (RSNE) of the AP and a Robust Security Network Extension Element (RSNXE) of the AP.

12. The method of claim 10, wherein the PASN MSG1 comprises a field that identifies a transient key adoption delay of the STA and wherein the third message is received from the AP after a time period has elapsed since receipt of the PASN MSG2, wherein the time period is greater than or equal to the transient key adoption delay of the STA.

13. The method of claim 10, wherein the PASN MSG2 comprises a field that identifies a transient key adoption delay of the AP and wherein the third message is received from the AP after a time period has elapsed since receipt of the PASN MSG2, wherein the time period is greater than or equal to the transient key adoption delay of the AP.

14. A method of operating an access point (AP) to communicate with a station (STA), the method comprising:
transmitting, using one or more antennas, a privacy beacon that is encrypted using a cryptographic key of the AP;
receiving, using one or more antennas, a first message from the STA that includes a station identifier (STA-ID);
attempting to verify, using one or more processors, the STA-ID in the first message based on a first network address of the AP, a second network address of the STA, the cryptographic key, and a cryptographic function; and
transmitting, using the one of more antennas responsive to verifying the STA-ID, a second message to the STA, the second message comprising information usable by the STA to encrypt a management frame used in associating the STA with the AP.

15. The method of claim 14, wherein attempting to verify the STA-ID comprises inputting the first network address, the second network address, and the cryptographic key to the cryptographic function and comparing an output of the cryptographic function to the STA-ID in the first message.

16. The method of claim 14, wherein the first message comprises a Pre-Association Security Negotiation (PASN) message 1 (MSG1) and the second message comprises a PASN message 2 (MSG2).

17. The method of claim 16, wherein the PASN message 1 comprises an AP security parameter request and a first transient key adoption delay, the PASN message 2 comprises a second transient key adoption delay, and the method further comprises:
transmitting, using the one or more antennas after transmission of the PASN MSG2 and prior to the STA associating with the AP, a set of AP security parameters to the STA, wherein
the set of AP security parameters are encrypted using a transient key derived by the AP based at least in part on the PASN MSG1,
the AP transmits the set of AP security parameters after a time period has elapsed from transmission of the PASN MSG2, and
the time period is longer than a larger of the first transient key adoption delay and the second transient key adoption delay.

18. A method of operating a station (STA) to communicate with an access point (AP), the method comprising:
transmitting, using a radio and one or more antennas communicatively coupled to the radio, a Pre-Association Security Negotiation (PASN) message to the AP, wherein the PASN message includes a payload that comprises:
a STA identifier (STA-ID) field, the STA-ID field including a STA-ID usable by the AP to verify that the STA is authorized to receive a set of security parameters from the AP; and
associating, using the radio, with the AP based on the set of security parameters.

19. The method of claim 18, wherein the payload of the PASN message further comprises:
a transient key (TK) adoption delay field;
a TK adoption delay present field corresponding to the TK adoption delay field;
a STA-ID present field corresponding to the STA-ID field; and
an AP information requested field.

20. The method of claim 19, wherein:
the TK adoption delay field and the STA-ID field are in a PASN parameters element format,
the TK adoption delay field is between the STA-ID field and an ephemeral public key field of the payload,
the ephemeral public key field is in the PASN parameters element format,
the TK adoption delay present field, the STA-ID present field, and the AP information requested field are in a PASN parameters element control information field format, and
the STA-ID present field is between the TK adoption delay present field and the AP information requested field of the payload.
